(19) United States
(12) Patent Application Publication
(10) Pub. No.: US 2014/0202620 A1
(43) Pub. Date: Jul. 24, 2014

(54) MOLDING ROLLER, APPARATUS AND METHOD FOR MANUFACTURING SAME

(71) Applicant: HON HAI PRECISION INDUSTRY CO., LTD., New Taipei (TW)

(72) Inventor: CHIA-LING HSU, New Taipei (TW)

(73) Assignee: HON HAI PRECISION INDUSTRY CO., LTD., New Taipei (TW)

(21) Appl. No.: 13/953,950

(22) Filed: Jul. 30, 2013

(30) Foreign Application Priority Data
Jan. 24, 2013 (TW) 102102572

(51) Int. Cl. B29D 99/00

(52) U.S. Cl. CPC B29D 99/0032
USPC 156/187; 156/446

(57) ABSTRACT

An apparatus includes a mixing assembly, a metallic plate, a curing device, a film chemical treatment device, a mounting device, and a cutting device. The mixing assembly obtains a polymer resin with polymer grids. The metallic plate has an impression surface with a number of impression patterns, and the polymer resin is poured on the impression surface. The curing device cures the polymer resin on the impression surface to obtain a preprocessed molding film, the preprocessed molding film having a molding surface in contact with the impression surface. The film chemical treatment device forms a number of silica nanoparticles in the polymer grids of the preprocessed molding film to obtain a molding film. The mounting device winds the molding film around a circumferential surface of a main body. The cutting device cuts the molding film. The molding film and the main body cooperatively form a molding roller.

### BACKGROUND

1. Technical Field

The present disclosure relates to a molding roller, an apparatus and a method for manufacturing the molding roller.

2. Description of Related Art

Optical films include a number of micro structures. One method for forming the micro structures is a roll forming process using a metal roller. The metallic roller has a circumferential surface including molding patterns for forming the micro structures. The molding pattern is formed by a laser knife. However, it is difficult to machine the molding patterns on a curved surface of the metallic roller, therefore, the machining efficiency is relatively low.

Therefore, it is desirable to provide a molding roller, an apparatus and a method for manufacturing the molding roller that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a molding roller, according to a first exemplary embodiment.

FIG. 2 is a schematic view of an apparatus for manufacturing a molding roller, according to a second exemplary embodiment.

FIG. 3 to FIG. 5 are flowcharts of a method for manufacturing a molding roller, according to a third exemplary embodiment.

### DETAILED DESCRIPTION

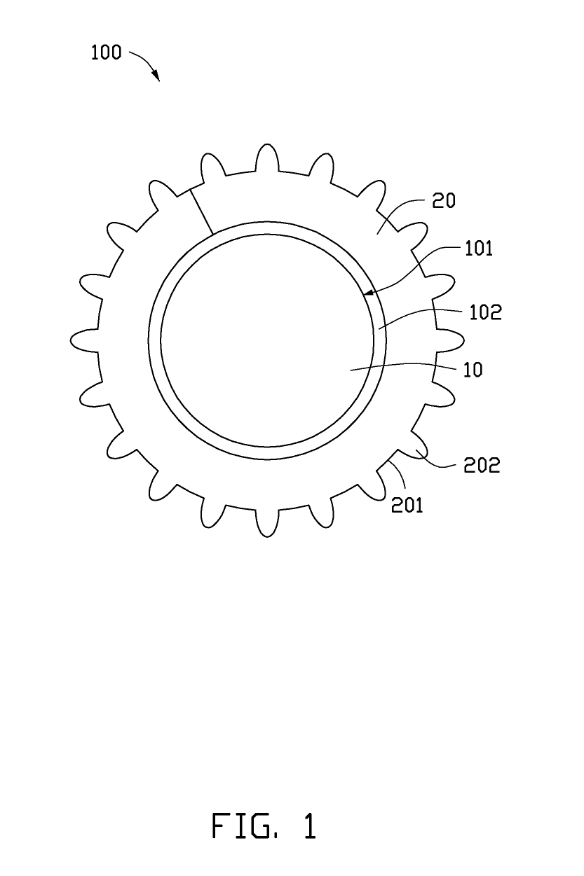

FIG. 1 illustrates a molding roller 100 in accordance with a first exemplary embodiment. The molding roller 100 includes a cylindrical main body 10 and a ring-shaped molding film 20. The main body 10 includes a circumferential surface 101, and can be made of stainless steel or other metals. The circumferential surface 101 is coated with an adhesive glue 102.

The molding film 20 is wound around and fixed to the circumferential surface 101 of the main body 10 via the adhesive glue 102. The molding film 20 includes a molding surface 201 opposite to the main body 10. The molding surface 201 includes a number of molding patterns 202. In the first embodiment, the molding patterns 202 are micro striped protrusions. In other embodiments, the molding patterns 202 can be micro-dots, micro domes, or micro striped grooves.

The molding film 20 is made of flexible polymer material. The flexible polymer material consists of polymer resin and a number of silica nanoparticles formed in polymer grids of the polymer resin. In the first embodiment, the polymer resin is polydimethylsiloxane (PDMS) resin, and the silica nanoparticles are formed by sol-gel method.

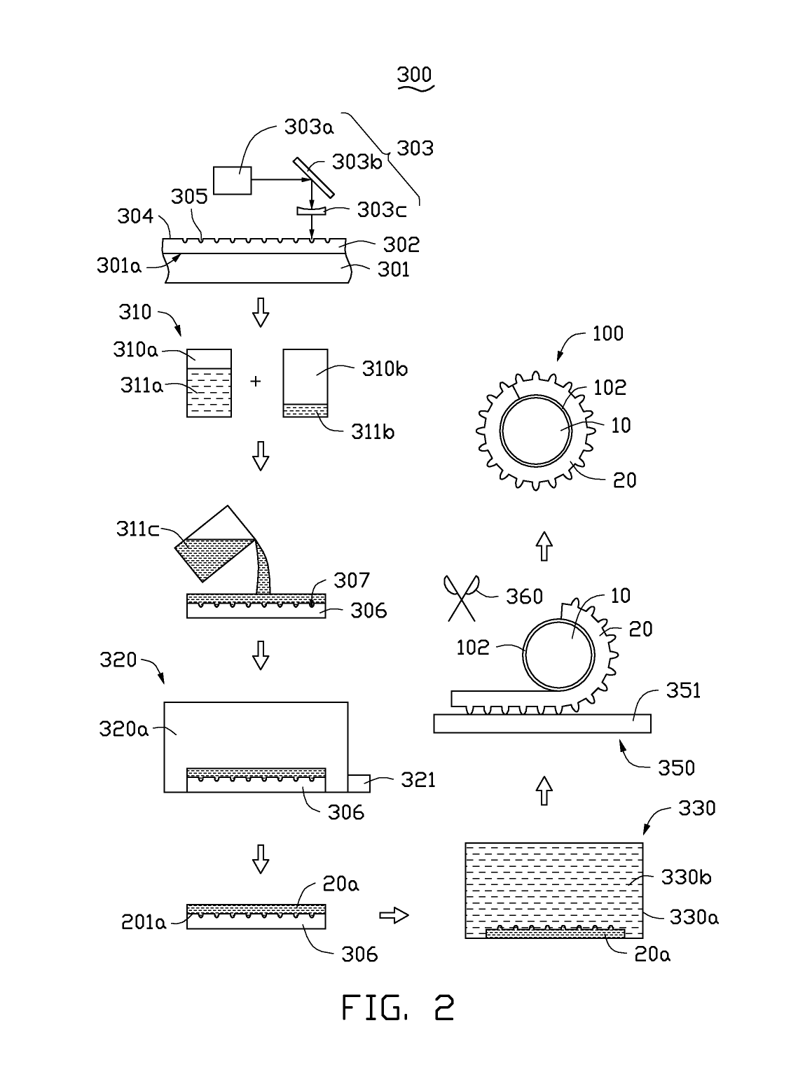

FIG. 2 illustrates an apparatus 300 for manufacturing the molding roller 100 according to a second exemplary embodiment. The apparatus 300 includes a loading plate 301, a preprocessed metallic plate 302, a processing device 303, a mixing assembly 310, a curing device 320, a film chemical treatment device 330, a mounting device 350, and a cutting device 360.

The loading plate 301 has a planar loading surface 301a. The preprocessed metallic plate 302 is fixed on the planar loading surface 301a, and includes a planar preprocessed impression surface 304 opposite to the loading plate 301. The processing device 303 is used for forming a number of impression patterns 305 on the planar preprocessed impression surface 304 to obtain a metallic plate 306 and an impression surface 307. In the second embodiment, the impression patterns 305 are micro-grooves, and the processing device 303 includes a laser emitter 303a, a reflector 303b, and a converging lens 303c. The laser emitter 303a is used for emitting laser rays. The transmitting direction of the laser rays is substantially parallel to the preprocessed impression surface 304. The reflector 303b is used for changing the transmitting direction of the laser rays and reflecting the laser rays to the converging lens 303c. The converging lens 303c converges the laser rays to the preprocessed impression surface 304. In other embodiments, the reflector 303b and the converging lens 303c can be omitted, and the transmitting direction of the laser rays should be substantially perpendicular to the preprocessed impression surface 304. In other embodiments, if the impression patterns 305 are V-shaped grooves, and the processing device 303 can include a diamond knife having a V-shaped blade.

The mixing assembly 310 includes a first container 310a and a second container 310b. The first container 310a is used for receiving a PDMS base, and the second container 310b is used for receiving a curing agent. The weight ratio of the PDMS base 311a to the curing agent 311b is about 10:1. When the PDMS base 311a is mixed with the curing agent 311b, the PDMS base 311a chemically reacts with the curing agent 311b to harden the PDMS base 311a, and thus the polymer resin 311c (i.e. PDMS resin) having polymer grids is obtained. The polymer resin 311c is uniformly poured on the impression surface 307 of the metallic plate 306. In the second embodiment, the first container 310a and the second container 310b can be measuring glasses.

The curing device 320 is used for solidifying the polymer resin 311c on the metallic plate 306 to obtain a preprocessed molding film 20a and a preprocessed molding surface 201a. In this embodiment, the curing device 320 includes a vacuum chamber 320a having a vent 321. The air in the vacuum chamber 320a can be drawn out through the vent 321, and thus a number of air bubbles in the polymer resin 311c can be removed. When the temperature of the vacuum chamber 320a is gradually increased, the polymer resin 311c can be solidified to obtain the preprocessed molding film 20a. The preprocessed molding surface 201a is coupled with the impression surface 307, and thus the preprocessed molding surface 201a has a number of molding patterns 202 coupled with the impression patterns 305. In the second embodiment, the molding patterns 202 are micro-protrusions.

The film chemical treatment device 330 is used for forming the silica nanoparticles in the polymer grids of the preprocessed molding film 20a to form the molding film 20. The film chemical treatment device 330 includes a container 330a for receiving a reaction liquid 330b. The reaction liquid 330b includes dibutyl tin diacetate (DBTDA) and tetraethoxy silane (TEOS). The preprocessed molding film 20a is immersed in the reaction liquid 330b for a first predetermined period, and thus the reaction liquid 330b penetrates the preprocessed molding film 20a, then the preprocessed molding film 20a is taken out from the container 330a, and is placed in the air for a second predetermined period. The DBTDA is hydrolyzed to obtain acetic acid. The acetic acid can accelerate the reaction of TEOS with the preprocessed molding film 20a to form the silica nanoparticles in the polymer grids of the preprocessed molding film 20a.

The mounting device 350 is used for mounting the molding film 20 on the circumferential surface 101 of the main body 10, and includes a working platform 351. The molding film 20 is positioned on the working platform 351, and the molding patterns 202 are in contact with the working platform 351. The circumferential surface 101 is coated with the adhesive glue 102, and the main body 10 presses an end of the molding film 20, then the main body 10 is rolled on the molding film 20 to make the molding film 20 wound around the circumferential surface 101 of the main body 10.

The cutting device 360 is used for cutting the molding film 20. The molding film 20 and the main body 10 corporate to form the molding roller 100.

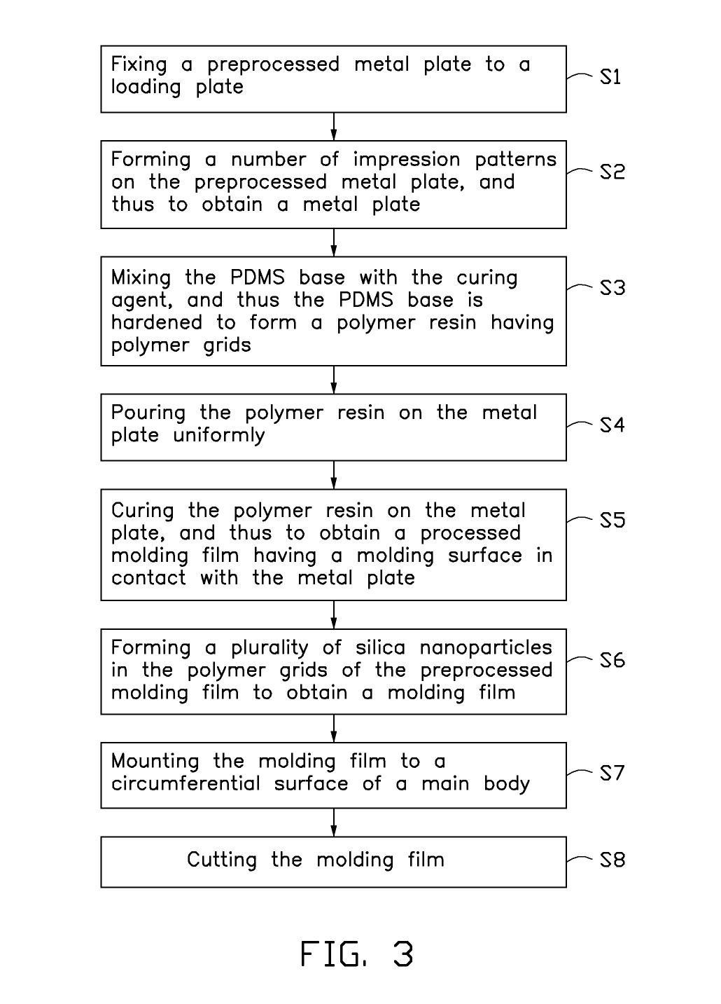

FIG. 3 illustrates a method for manufacturing the molding roller 100 using the apparatus 300 according to a third exemplary embodiment. The method includes the following steps.

In step S1, the preprocessed metallic plate 302 is provided and fixed to the planar loading surface 301a of the loading plate 301. The processed metallic plate 302 has a planar preprocessed impression surface 304 opposite to the loading plate 301.

In step S2, the impression patterns 305 are formed on the planar preprocessed impression surface 304 using the processing device 303, and thus the metallic plate 306 with the impression surface 307 are obtained. In the third embodiment, the processing device 303 emits laser light to process the metallic plate 302.

In step S3, the PDMS base 311a is mixed with the curing agent 311b using the mixing assembly 310, and thus the PDMS base 311a is hardened to form the polymer resin 311c. In this embodiment, the PDMS base 311a is received in the first container 310a, the curing agent 311b is received in the second container 310b, and the weight ratio of the PDMS base 311a to the curing agent 311b is about 10:1.

In step S4, the polymer resin 311c is uniformly poured on the impression surface 307 of the metallic plate 306.

In step S5, the metallic plate 306 with the polymer resin 311c is received in the curing device 320, the air of the curing device 320 is drawn out, and thus the air bubbles in the polymer resin 311c are removed, and then the curing device 320 cures the polymer resin 311c, and the preprocessed molding film 20a is obtained. The preprocessed molding film 20a has the molding surface 201 in contact with the impression surface 307. The molding surface 201 has a number of molding patterns 202 coupled with the impression patterns 305.

In step S6, the preprocessed molding film 20a is separated from the metallic plate 306, and a number of silica nanoparticles are formed in the polymer grids of the preprocessed molding film 20a using the film chemical treatment device 330, and thus the molding film 20 is obtained.

In step S7, the molding film 20 is wound around and fixed to the circumferential surface 101 of the main body 10 using the mounting device 350, and the molding surface 201 is opposite to the circumferential surface 101.

In step S8, the molding film 30 is cut by the cutting device 360.

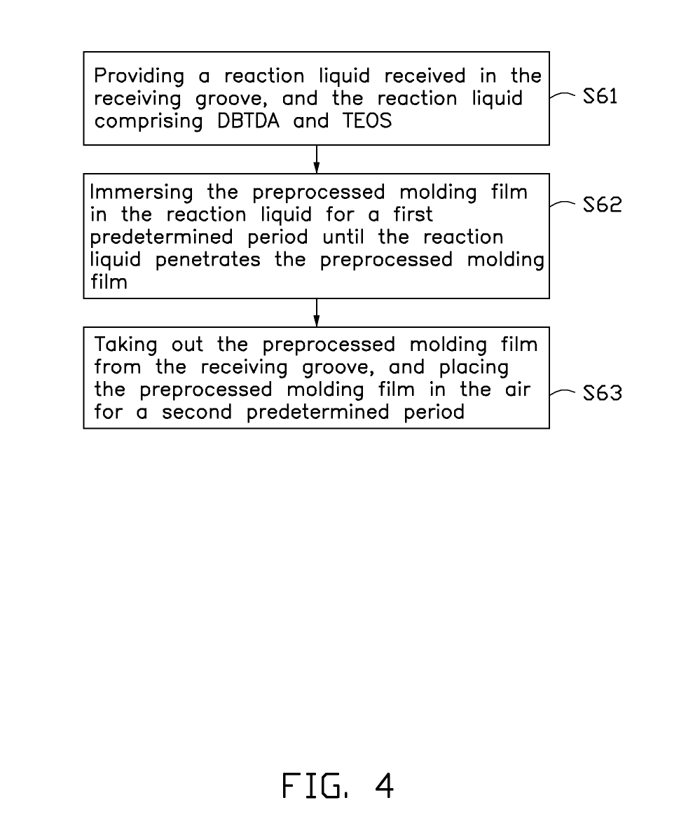

FIG. 4 illustrates that the step S6 includes the following sub-steps.

In step S61, the reaction liquid 330b is provided and is received in the receiving groove 330a, and the reaction liquid 330b includes DBTDA and TEOS.

In step S62, the preprocessed molding film 20a is immersed in the reaction liquid 330b for the first predetermined period, and thus the reaction liquid 330b penetrates the preprocessed molding film 20a.

In step S63, the preprocessed molding film 20a is taken out from the receiving groove 330a, and is placed in the air for the second predetermined period, and thus the DBTDA is hydrolyzed to obtain acetic acid. The acetic acid can accelerate the reaction of the TEOS with the preprocessed molding film 20a to form the silica nanoparticles in the polymer grids of the preprocessed molding film 20a.

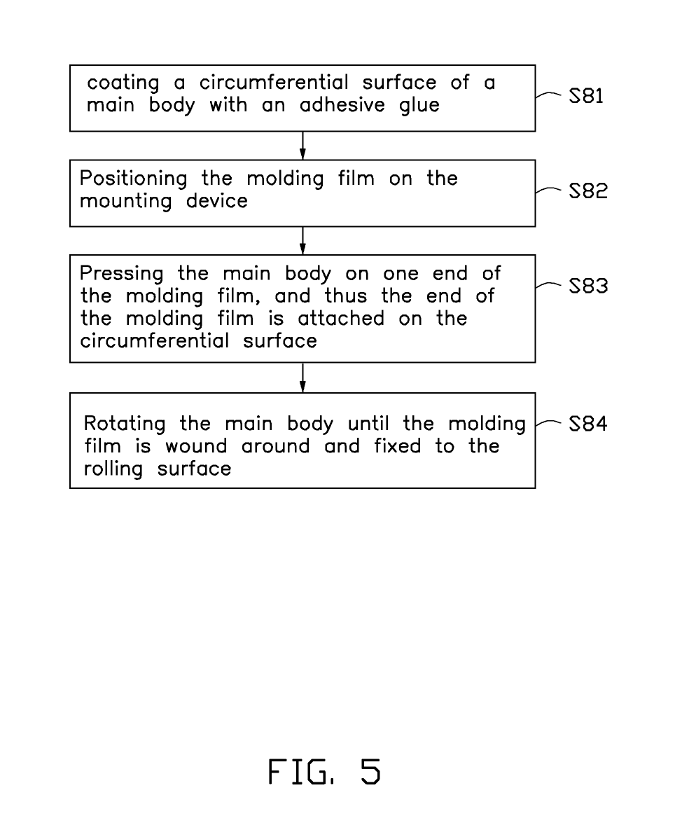

FIG. 5 illustrates that the step S7 further includes the following sub-steps.

In step S71, the circumferential surface 101 is coated with the adhesive glue 102.

In step S72, the molding film 20 is positioned on the mounting device 350, and the molding surface 201 is opposite to the main body 10.

In step S73, the main body 10 presses an end of the molding film 20, and thus the end of the molding film 20 is attached on the circumferential surface 101.

In step S74, the main body 10 is rotated until the molding film 20 is wound around and fixed to the rolling surface 101.

By employing the apparatus 300 and the above described method, it is easier for the processing device 303 to machine the impression patterns 305 on the planar preprocessed impression surface 304 relative to on a curved surface. Therefore, the machining efficiency is improved.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An apparatus for manufacturing a molding roller, comprising:
a mixing assembly configured for obtaining a polymer resin with polymer grids;
a metallic plate having an impression surface with a plurality of impression patterns, and the polymer resin configured for being poured on the impression surface;
a curing device configured for curing the polymer resin on the impression surface to obtain a preprocessed molding film, the preprocessed molding film having a molding surface in contact with the impression surface, and the molding surface having a plurality of molding patterns mated with the impression patterns;
a film chemical treatment device configured for forming a plurality of silica nanoparticles in the polymer grids of the preprocessed molding film to obtain a molding film;
a mounting device configured for winding the molding film around a circumferential surface of a main body, wherein the molding patterns are opposite to the main body; and
a cutting device for cutting the molding film, and the molding film and the main body cooperatively forming the molding roller.

2. The apparatus of claim 1, wherein the mixing assembly mixes a polydimethylsiloxane base and a curing agent to obtain the polymer resin.

3. The apparatus of claim 2, wherein the weight ratio of the polydimethylsiloxane base to the curing agent is about 10:1.

4. The apparatus of claim 1, wherein the curing device comprises a vacuum chamber having a vent, when the metallic plate with the polymer resin is received in the vacuum chamber, the air in the vacuum chamber is drawn out through the vent, and then the temperature of the vacuum chamber is gradually increased, and thus the polymer resin is solidified to obtain the preprocessed molding film.

5. The apparatus of claim 1, wherein the film chemical treatment device comprises a receiving groove for receiving a reaction liquid, the reaction liquid comprises dibutyl tin diacetate and tetraethoxy silane, the preprocessed molding film is immersed in the reaction liquid for a predetermined period, and thus the reaction liquid penetrates the preprocessed molding film, then the preprocessed molding film is taken out from the receiving groove, the dibutyl tin diacetate is hydrolyzed to obtain acetic acid, the acetic acid accelerates the reaction of the tetraethoxy silane with the preprocessed molding film to form the silica nanoparticles in the polymer grids of the preprocessed molding film.

6. The apparatus of claim 1, comprising a loading plate and a processing device, the loading plate configured for loading a preprocessed metallic plate having a preprocessed impression surface, the processing device configured for forming a plurality of impression patterns on the preprocessed impression surface to obtain the metallic plate.

7. The apparatus of claim 6, wherein the processing device comprises a laser emitter, a reflector, and a converging lens, the laser emitter emits laser rays, the transmitting direction of the laser rays is substantially parallel to the preprocessed impression surface, the reflector changes the transmitting direction of the laser rays and reflecting the laser rays to the converging lens, the converging lens converges the laser rays to the preprocessed impression surface.

8. A method for manufacturing a molding roller, comprising:
obtaining a polymer resin with polymer grids using a mixing assembly;
pouring the polymer resin on a metallic plate with a plurality of impression patterns;
curing the polymer resin on the metallic plate using a curing device, so as to obtain a processed molding film having a molding surface in contact with the impression surface, wherein the molding surface has a plurality of molding patterns mated with the impression patterns;
forming a plurality of silica nanoparticles in the polymer grids of the preprocessed molding film to obtain a molding film using a film chemical treatment device;
mounting the molding film to a circumferential surface of a main body using a mounting device; and
cutting the molding film using a cutting device.

9. The method of claim 8, wherein the step of obtaining a polymer resin with polymer grids using a mixing assembly further comprises:
receiving a polydimethylsiloxane base in a first container;
receiving a curing agent in a second container; and
mixing the polydimethylsiloxane base and the curing agent.

10. The method of claim 8, wherein the step of curing the polymer resin on the metallic plate using a curing device further comprises:
receiving the metallic plate on the polymer resin in a vacuum chamber;
drawing out the air from the vacuum chamber; and
gradually increasing the temperature of the vacuum chamber until the polymer resin is solidified.

11. The method of claim 8, wherein the step of curing the polymer resin on the metallic plate using a curing device further comprises:
providing a reaction liquid received in a receiving groove, and the reaction liquid comprising dibutyl tin diacetate and tetraethoxy silane;
immersing the preprocessed molding film in the reaction liquid for a first predetermined period until the reaction liquid penetrates the preprocessed molding film;
taking out the preprocessed molding film from the receiving groove; and
placing the preprocessed molding film in the air for a second predetermined period, such that the dibutyl tin diacetate is hydrolyzed to obtain acetic acid, the acetic acid accelerating the reaction of the tetraethoxy silane with the preprocessed molding film to form the silica nanoparticles in the polymer grids of the preprocessed molding film.

12. The method of claim 8, wherein the step of pouring the polymer resin on a metallic plate with a plurality of impression patterns further comprises:
fixing a preprocessed metallic plate on a loading plate, the preprocessed metallic plate having a preprocessed impression surface opposite to the loading plate; and
forming the impression patterns on the preprocessed impression surface using a processing device.

13. The method of claim 8, wherein the step of mounting the molding film to a circumferential surface of a main body using a mounting device further comprises:
coating the circumferential surface with an adhesive glue;
positioning the molding film on the mounting device, wherein the molding surface is opposite to the main body;
pressing the main body on one end of the molding film, with the end of the molding film attached on the circumferential surface; and
rotating the main body until the molding film is wound around and fixed to the circumferential surface.
